(19) United States
(12) Patent Application Publication
(10) Pub. No.: US 2026/0316012 A1
(43) Pub. Date: Oct. 15, 2026

(54) POROUS MEMBRANE, STACKED BODY, AND FILTER ELEMENT

(71) Applicants: Sumitomo Electric Fine Polymer, Inc., Sennan-gun, Osaka (JP); Sumitomo Electric Industries, Ltd., Osaka (JP)

(72) Inventors: Hirokazu KATAYAMA, Osaka (JP); Atsushi FUKUNAGA, Osaka (JP); Hiroyuki TSUJIWAKI, Sennan-gun, Osaka (JP); Takamasa HASHIMOTO, Sennan-gun, Osaka (JP); Yutaka MURATA, Sennan-gun, Osaka (JP); Yutaro MATSUKATA, Sennan-gun, Osaka (JP); Fumihiro HAYASHI, Sennan-gun, Osaka (JP); Kazuya TOKUDA, Osaka (JP)

(73) Assignees: Sumitomo Electric Fine Polymer, Inc., Sennan-gun, Osaka (JP); Sumitomo Electric Industries, Ltd., Osaka (JP)

(21) Appl. No.: 19/485,358

(22) PCT Filed: Apr. 18, 2024
(86) PCT No.: PCT/JP2024/015432

§ 371 Date: Nov. 18, 2025

(30) Foreign Application Priority Data
May 22, 2023 (JP) 2023-084099

(51) Int. Cl. B01D 69/02; B01D 61/14; B01D 69/10; B01D 71/36

(52) U.S. Cl. CPC B01D 69/02; B01D 69/107; B01D 71/36; B01D 61/147; B01D 2325/20; B01D 2325/52

(57) ABSTRACT

A porous membrane comprising polytetrafluoroethylene as a main component, wherein the porous membrane has a Gurley second and an average bubble point, the Gurley second and the average bubble point satisfy a relation of the following formula 1 or formula 2: G1<0.035×P1a Formula 1, G1<0.020×P1b Formula 2. In each of the formula 1 and the formula 2, G1 represents the Gurley second of the porous membrane, in the formula 1, P1a represents the average bubble point of the porous membrane, the P1a is measured by a bubble point method using a first-a liquid, a surface tension of the first-a liquid is 13 mN/m, in the formula 2, P1b represents the average bubble point of the porous membrane, the P1b is measured by a bubble point method using a first-b liquid, and a surface tension of the first-b liquid is 21 mN/m.

### TECHNICAL FIELD

The present disclosure relates to a porous membrane, a stacked body, and a filter element. The present application claims priority based on Japanese Patent Application No. 2023-084099 filed on May 22, 2023. The entire contents of the Japanese Patent Application are incorporated herein by reference.

### BACKGROUND ART

Conventionally, a porous membrane including polytetrafluoroethylene as a main component has been used as a microfiltration filter for a dispersion medium and a base substance in a semiconductor-related field or the like (PTL 1 to PTL 6 and NPL 1).

### CITATION LIST

### Patent Literature

PTL 1: Japanese Patent Laying-Open No. 2021-54892
PTL 2: WO 2007/011492
PTL 3: WO 2020/251909
PTL 4: WO 2020/251912
PTL 5: Japanese Patent Laying-Open No. 2015-226877
PTL 6: Japanese Patent Laying-Open No. 2021-178948

### Non Patent Literature

NPL 1: Kobunshi Ronbunshu, Vol. 66, No. 12, pp. 585 to 590 (December 2009).

### SUMMARY OF INVENTION

A porous membrane according to one embodiment of the present disclosure is a porous membrane comprising polytetrafluoroethylene as a main component, wherein
the porous membrane has a Gurley second and an average bubble point,
the Gurley second and the average bubble point satisfy a relation of the following formula 1 or formula 2:

G1<0.035×P1a Formula 1

G1<0.020×P1b Formula 2
in each of the formula 1 and the formula 2, G1 represents the Gurley second of the porous membrane,
in the formula 1, P1a represents the average bubble point of the porous membrane,
the P1a is measured by a bubble point method using a first-a liquid,
a surface tension of the first-a liquid is 13 mN/m,
in the formula 2, P1b represents the average bubble point of the porous membrane,
the P1b is measured by a bubble point method using a first-b liquid, and
a surface tension of the first-b liquid is 21 mN/m.

### BRIEF DESCRIPTION OF DRAWINGS

FIG. 1 is a schematic enlarged cross sectional view of a porous membrane according to one embodiment of the present disclosure.

FIG. 2 is a schematic enlarged cross sectional view of a stacked body according to one embodiment of the present disclosure.

FIG. 3 is a perspective view of a filter element (1) according to one embodiment of the present disclosure.

FIG. 4 is a perspective view of a filter element (2) according to one embodiment of the present disclosure.

### DETAILED DESCRIPTION

### [Problem to be Solved by the Present Disclosure]

From the viewpoint of capturing finer particles or the like in the microfiltration for a dispersion medium and a base substance in the semiconductor-related field or the like, each of a porous membrane having a high average bubble point and a stacked body including the porous membrane has been required as a filter for the microfiltration. It should be noted that here, the average bubble point is an index indicating how difficult it is for particles or the like to pass therethrough. As the average bubble point is higher, it is more difficult for the particles or the like to pass therethrough. Therefore, inclusion of a high average bubble point means that capturing performance for fine particles is excellent.

Moreover, from the viewpoint of increasing permeation efficiency in the microfiltration, it has been required to increase a flow rate of a filtrate with respect to each of the porous membrane and the stacked body including the porous membrane (in other words, it has been required to decrease a Gurley second of each of the porous membrane and the stacked body including the porous membrane).

However, it has been known that when the average bubble point is high in each of the porous membrane and the stacked body including the porous membrane, the flow rate of the filtrate with respect to each of the porous membrane and the stacked body including the porous membrane tends to be low (in other words, the Gurley second of the porous membrane and the stacked body including the porous membrane tends to be high). Therefore, in some cases, it is difficult to attain a high average bubble point and a low Gurley second in each of the porous membrane and the stacked body including the porous membrane. That is, in some cases, it is difficult for each of the porous membrane and the stacked body including the porous membrane to have both excellent capturing performance for fine particles and excellent permeation efficiency.

Therefore, an object of the present disclosure is to provide a porous membrane having both excellent capturing performance for fine particles and excellent permeation efficiency, a filter element including the porous membrane, a stacked body having both excellent capturing performance for fine particles and excellent permeation efficiency, and a filter element including the stacked body.

### ADVANTAGEOUS EFFECT OF THE PRESENT DISCLOSURE

According to the present disclosure, it is possible to provide a porous membrane having both excellent capturing performance for fine particles and excellent permeation efficiency, a filter element including the porous membrane, a stacked body having both excellent capturing performance for fine particles and excellent permeation efficiency, and a filter element including the stacked body.

### DESCRIPTION OF EMBODIMENTS

First, embodiments of the present disclosure will be listed and described.

[1] A porous membrane according to one embodiment of the present disclosure is a porous membrane comprising polytetrafluoroethylene as a main component, wherein
the porous membrane has a Gurley second and an average bubble point,
the Gurley second and the average bubble point satisfy a relation of the following formula 1 or formula 2:

G1<0.035×P1a Formula 1

G1<0.020×P1b Formula 2
in each of the formula 1 and the formula 2, G1 represents the Gurley second of the porous membrane,
in the formula 1, P1a represents the average bubble point of the porous membrane,
the P1a is measured by a bubble point method using a first-a liquid,
a surface tension of the first-a liquid is 13 mN/m,
in the formula 2, P1b represents the average bubble point of the porous membrane,
the P1b is measured by a bubble point method using a first-b liquid, and
a surface tension of the first-b liquid is 21 mN/m.

According to the present disclosure, it is possible to provide a porous membrane having both excellent capturing performance for fine particles and excellent permeation efficiency, and a filter element including the porous membrane.

[2] In [1], the P1a may be 450 kPa or more, and the P1b may be 900 kPa or more. Thus, it is possible to provide a porous membrane having both more excellent capturing performance for fine particles and more excellent permeation efficiency, and a filter element including the porous membrane.

[3] In [1] or [2], the porous membrane may have a crystallite,
the crystallite may have a length X along a MD direction of the porous membrane and a length Y along the TD direction of the porous membrane, and
a product XY of the length X and the length Y may be less than 1200 nm².
   Thus, it is possible to provide a porous membrane having both more excellent capturing performance for fine particles and more excellent permeation efficiency, and a filter element including the porous membrane.

[4] A filter element according to one embodiment of the present disclosure includes the porous membrane according to any one of [1] to [3].

According to the present disclosure, it is possible to provide a filter element including a porous membrane having both excellent capturing performance for fine particles and excellent permeation efficiency.

[5] A stacked body according to one embodiment of the present disclosure is a stacked body comprising: one or a plurality of the porous membranes according to any one of [1] to [3]; and a support membrane located on one surface or each of both surfaces of at least one porous membrane of the porous membranes, wherein
the support membrane is porous,
the support membrane includes polytetrafluoroethylene as a main component,
the stacked body has a Gurley second and an average bubble point,
the Gurley second of the stacked body and the average bubble point of the stacked body satisfy a relation of the following formula 3 or formula 4:

G2<0.040×P2a Formula 3

G2<(0.025×P2b)−6 Formula 4
in each of the formula 3 and the formula 4, G2 represents the Gurley second of the stacked body,
in the formula 3, P2a represents the average bubble point of the stacked body,
the P2a is measured by a bubble point method using a second-a liquid,
a surface tension of the second-a liquid is 13 mN/m,
in the formula 4, P2b represents the average bubble point of the stacked body,
the P2b is measured by a bubble point method using a second-b liquid, and
a surface tension of the second-b liquid is 21 mN/m.

According to the present disclosure, it is possible to provide a stacked body having both excellent capturing performance for fine particles and excellent permeation efficiency, and a filter element including the stacked body.

[6] In [5], the P2a may be 510 kPa or more, and
the P2b may be 1000 kPa or more. Thus, it is possible to provide a stacked body having both more excellent capturing performance for fine particles and more excellent permeation efficiency, and a filter element including the stacked body.

[7] A filter element according to one embodiment of the present disclosure includes the stacked body according to [5] or [6].

According to the present disclosure, it is possible to provide a filter element including a stacked body having both excellent capturing performance for fine particles and excellent permeation efficiency.

### DETAILS OF EMBODIMENTS OF THE PRESENT DISCLOSURE

Hereinafter, one embodiment (hereinafter, referred to as the “present embodiment”) of the present disclosure will be described. However, the present embodiment is not limited thereto. In the present specification, the expression “A to B” means the lower and upper limits of a range (i.e., A or more and B or less), and when no unit is indicated for A and a unit is indicated only for B, the unit of A and the unit of B are the same.

In the present specification, when a compound or the like is expressed by a chemical formula and an atomic ratio is not particularly limited, the atomic ratio includes all the conventionally known atomic ratios and should not be necessarily limited only to one in the stoichiometric range.

### First Embodiment: Porous Membrane

A porous membrane 1 according to one embodiment of the present disclosure will be described with reference to FIG. 1.

One embodiment (hereinafter, also referred to as the “present embodiment”) of the present disclosure is directed to a porous membrane 1 comprising polytetrafluoroethylene as a main component, wherein
porous membrane 1 has a Gurley second and an average bubble point.

In porous membrane 1 according to the present embodiment, the Gurley second and the average bubble point satisfy a relation of the following formula 1 or formula 2:

G1<0.035×P1a Formula 1

G1<0.020×P1b Formula 2.

Even when the fiber of the porous membrane becomes thin to result in a high fiber density (in other words, even when the average bubble point of the porous membrane becomes high), a porosity ratio is high. Therefore, with porous membrane 1, an increased Gurley second due to the high average bubble point can be suppressed. As a result, porous membrane 1 can have both excellent capturing performance for fine particles and excellent permeation efficiency.

It should be noted that the average bubble point is measured by a bubble point method, and a specific liquid is used in the bubble point method. The numerical value of the average bubble point differs depending on a surface tension of the specific liquid. From the viewpoint of difficulty in obtaining the specific liquid, the formula 1 for the “P1a” measured by a bubble point method using a “first-a liquid” and the formula 2 for the “P1b” measured by a bubble point method using a “first-b liquid” are defined.

### <<Composition of Porous Membrane>>

Porous membrane 1 includes polytetrafluoroethylene as a main component. It should be noted that here, the “main component” means a component having the largest content in terms of mass, such as a component having a content of 90 mass % or more, preferably 95 mass % or more. Porous membrane 1 may consist of polytetrafluoroethylene. It should be noted that the expression “porous membrane 1 consists of polytetrafluoroethylene” means that porous membrane 1 can include an inevitable impurity as long as the effect of the present disclosure is exhibited. Further, in the present application, the “polytetrafluoroethylene” is a polymer of tetrafluoroethylene, and represents a concept including a homopolymer of tetrafluoroethylene and a modified substance of the “homopolymer of tetrafluoroethylene”. Examples of the modified substance include: a tetrafluoroethylene-hexafluoropropylene copolymer (in other words, perfluoroethylene propene copolymer; hereinafter, also referred to as “FEP”); a tetrafluoroethylene-perfluoroalkyl vinyl ether copolymer (PFA); an ethylene-tetrafluoroethylene copolymer (ETFE); and the like. The modified substance can include 0.1 mol % or less of hexafluoropropylene (HFP), perfluoro (alkyl vinyl ether) (FVE), or the like.

In porous membrane 1, the content of the polytetrafluoroethylene can be specified based on an absorbance of “—CF₂—” indicating tetrafluoroethylene (TFE) at an absorption wavelength of 4.25 μm, an absorbance of “—CH₃ group” indicating FEP at an absorption wavelength of 10.18 μm, an absorbance of “CF₃O— group” indicating PFA at an absorption wavelength of 10.07 μm, and the like. It should be noted that it has been confirmed that the same results are obtained even when different measurement ranges are freely selected in the same porous membrane 1.

### <<Shape of Porous Membrane>>

The thickness of porous membrane 1 may be 0.002 mm or more and 0.100 mm or less. When the thickness is less than 0.002 mm, the strength of porous membrane 1 tends to be insufficient. When the thickness is more than 0.100 mm, pressure loss during permeation of a filtrate tends to be large. The lower limit of the thickness of porous membrane 1 may be 0.002 mm or more, 0.005 mm or more, or 0.010 mm or more. The upper limit of the thickness of porous membrane 1 may be 0.100 mm or less, 0.090 mm or less, or 0.080 mm or less. The thickness of porous membrane 1 may be 0.005 mm or more and 0.090 mm or less, or may be 0.010 mm or more and 0.080 mm or less.

The thickness of porous membrane 1 can be specified by the following method. First, a thickness thereof at any one location is measured using a standard type digital thickness gauge. Then, the standard type digital thickness gauge is used to measure thicknesses thereof at any other nine locations. Next, the average value of the thicknesses at the total of ten locations is calculated, thereby specifying the thickness of porous membrane 1.

It should be noted that it has been confirmed that the same results are obtained even when different measurement ranges are freely selected in the same porous membrane and the above-described measurement is performed in the measurement ranges.

Porous membrane 1 has an elongated shape.

### <<Density of Porous Membrane>>

The density of porous membrane 1 may be 0.05 g/cm³ or more and 2.00 g/cm³ or less. When the density is less than 0.05 g/cm³, the strength of porous membrane 1 tends to be insufficient. When the density is more than 2.00 g/cm³, the permeation efficiency of porous membrane 1 tends to be decreased. The lower limit of the density of porous membrane 1 may be 0.05 g/cm³ or more, 0.10 g/cm³ or more, or 0.15 g/cm³ or more. The upper limit of the density of porous membrane 1 may be 2.00 g/cm³ or less, 1.70 g/cm³ or less, or 1.50 g/cm³ or less. The density of porous membrane 1 may be 0.10 g/cm³ or more and 1.70 g/cm³ or less, or may be 0.15 g/cm³ or more and 1.50 g/cm³ or less.

The density of porous membrane 1 can be specified by a method according to ASTM-D-792. It should be noted that it has been confirmed that the same results are obtained even when different measurement ranges are freely selected in the same porous membrane 1 and the above-described measurement is performed in the measurement ranges.

### <<Basis Weight of Porous Membrane>>

The basis weight of porous membrane 1 may be 0.002 mg/mm² or more and 0.100 mg/mm² or less. When the basis weight of porous membrane 1 is less than 0.002 mg/mm², the strength of porous membrane 1 tends to be insufficient. When the basis weight of porous membrane 1 is more than 0.100 mg/mm², the permeation efficiency of porous membrane 1 tends to be decreased. The lower limit of the basis weight of porous membrane 1 may be 0.002 mg/mm² or more, 0.003 mg/mm² or more, or 0.004 mg/mm² or more. The upper limit of the basis weight of porous membrane 1 may be 0.100 mg/mm² or less, 0.080 mg/mm² or less, or 0.060 mg/mm² or less. The basis weight of porous membrane 1 may be 0.003 mg/mm² or more and 0.080 mg/mm² or less, or may be 0.004 mg/mm² or more and 0.060 mg/mm² or less.

The basis weight of porous membrane 1 can be specified by the following method. First, porous membrane 1 is cut at any one location into a circular shape having a diameter of 60.0 mm, thereby obtaining an evaluation sample. Next, the mass of the evaluation sample is specified using an analytical balance “AP224X” (trademark) provided by Shimadzu Corporation. Next, the basis weight is determined by dividing the mass of the evaluation sample by the area of the evaluation sample (in other words, 30.0²×π). Next, the basis weight is specified for each of any other nine locations by the same method as described above. Next, the basis weight of porous membrane 1 can be specified by calculating the average value of the basis weights at the total of ten locations.

It should be noted that it has been confirmed that the same results are obtained even when different measurement ranges are freely selected in the same porous membrane 1 and the above-described measurement is performed in the measurement ranges.

### <<Average Bubble Point and Gurley Second>>

### <Average Bubble Point>

Porous membrane 1 has the average bubble point (P1a and P1b). The P1a may be 450 kPa or more. Thus, the fiber of porous membrane 1 is formed to be thin and is densely formed, with the result that porous membrane 1 can have both a higher average bubble point and a lower Gurley second. The lower limit of the P1a may be 450 kPa or more, 470 kPa or more, or 500 kPa or more. The upper limit of the P1a may be 900 kPa or less, 890 kPa or less, or 880 kPa or less. The P1a may be 470 kPa or more and 890 kPa or less, or may be 500 kPa or more and 880 kPa or less.

The P1b may be 900 kPa or more. Thus, the fiber of porous membrane 1 is formed to be thin and is densely formed, with the result that porous membrane 1 can have both a higher average bubble point and a lower Gurley second. The lower limit of the P1b may be 910 kPa or more, or 920 kPa or more. The upper limit of the P1b may be 1600 kPa or less, 1500 kPa or less, or 1400 kPa or less. The P1b may be 900 kPa or more and 1600 kPa or less, or 910 kPa or more and 1500 kPa or less.

In porous membrane 1, the P1a is measured by the bubble point method using the first-a liquid, and the surface tension of the first-a liquid is 13 mN/m. More specifically, in porous membrane 1, the P1a is specified by the following method. First, for porous membrane 1 in a dry state, differential pressure applied to porous membrane 1 and an air flow rate through porous membrane 1 are measured based on the bubble point method (ASTM F316-86; JIS K3832). Next, in coordinates in which the horizontal axis represents the differential pressure and the vertical axis represents the air flow rate, a first curve is obtained which indicates a relation between the differential pressure and a numerical value obtained by dividing the air flow rate by 2. Next, porous membrane 1 is immersed for 5 minutes at 25° C. in “Opteon SF70” (trademark), which is a hydrofluoroolefin (first-a liquid) provided by Chemours-Mitsui Fluoroproducts, and is taken out from the hydrofluoroolefin (first-a liquid), thereby obtaining porous membrane 1 wetted with the hydrofluoroolefin (first-a liquid). Next, for porous membrane 1 wetted with the hydrofluoroolefin (first-a liquid), the differential pressure applied to porous membrane 1 and the air flow rate through porous membrane 1 are measured based on the bubble point method. Next, in the coordinates in which the horizontal axis represents the differential pressure and the vertical axis represents the air flow rate, a second curve is obtained which indicates a relation between the differential pressure and the air flow rate. Next, a differential pressure at the intersection between the first curve and the second curve is specified as the average bubble point P1a. It should be noted that the surface tension of the hydrofluoroolefin (first-a liquid) is 13 mN/m.

In porous membrane 1, the P1b is measured by the bubble point method using the first-b liquid, and the surface tension of the first-b liquid is 21 mN/m. More specifically, in porous membrane 1, the P1b is specified in the same manner as in the method of measuring the P1a except that isopropyl alcohol (first-b liquid) provided by FUJIFILM Wako Pure Chemical Corporation is used instead of the first-a liquid.

### <Gurley Second>

Porous membrane 1 has the Gurley second (G1). In porous membrane 1, the G1 may be 1 second or more and 100 seconds or less. Thus, the flow rate of the filtrate can be high, with the result that the permeation efficiency can be high and the capturing performance for fine particles included in the filtrate can be high. The lower limit of the G1 may be 1 second or more, 3 seconds or more, or 5 seconds or more. The upper limit of the G1 may be 100 seconds or less, 80 seconds or less, or 60 seconds or less. The G1 may be 3 seconds or more and 80 seconds or less, or may be 5 seconds or more and 60 seconds or less.

In porous membrane 1, the G1 can be specified by the following method. In accordance with JIS P 8117, a time required for 100 ml of air to pass through a membrane effective area of 6.42 cm² at a differential pressure of 1.22 kPa is measured. The time is defined as the G1.

### <Relation Between Gurley Second and Average Bubble Point>

The Gurley second and the average bubble point satisfy the relation of the following formula 1 or formula 2:

G1<0.035×P1a Formula 1

G1<0.020×P1b Formula 2
in each of the formula 1 and the formula 2, the G1 represents the Gurley second of porous membrane 1,
in the formula 1, the P1a represents the average bubble point of porous membrane 1,
the P1a is measured by the bubble point method using the first-a liquid,
the surface tension of the first-a liquid is 13 mN/m,
in the formula 2, the P1b represents the average bubble point of porous membrane 1,
the P1b is measured by the bubble point method using the first-b liquid, and
the surface tension of the first-b liquid is 21 mN/m.

Thus, porous membrane 1 can have both a high average bubble point and a low Gurley second, and therefore can have both excellent capturing performance for fine particles and excellent permeation efficiency. It should be noted that in the formula 1, “0.035” means a slope in the linear function. In the formula 2, “0.020” means a slope in the linear function.

### <<Mean Flow Pore Diameter>>

The mean flow pore diameter of porous membrane 1 may be 25 nm or more and 70 nm or less. Thus, porous membrane 1 can have both high permeation efficiency and high capturing performance for fine particles included in the filtrate. The lower limit of the mean flow pore diameter may be 25 nm or more, 26 nm or more, or 27 nm or more. The upper limit of the mean flow pore diameter may be 70 nm or less, 67 nm or less, or 65 nm or less. The mean flow pore diameter may be 26 nm or more and 67 nm or less, or may be 27 nm or more and 65 nm or less.

The mean flow pore diameter of porous membrane 1 can be specified by the following measurement method. That is, first, for porous membrane 1 in a dry state, a differential pressure applied to porous membrane 1 and an air flow rate through porous membrane 1 are measured based on the bubble point method. Next, in coordinates in which the horizontal axis represents the differential pressure and the vertical axis represents the air flow rate, a third curve is obtained which indicates a relation between the differential pressure and a numerical value obtained by dividing the air flow rate by 2. Next, porous membrane 1 is immersed at 25° C. for 5 minutes in GALWICK (propylene, 1,1,2,3,3,3-oxidized hexahydrofluoric acid; fourth liquid) provided by Porous Materials, and is taken out from the GALWICK (fourth liquid), thereby obtaining porous membrane 1 wetted with the GALWICK (fourth liquid). Next, for porous membrane 1 wetted with the GALWICK (fourth liquid), the differential pressure applied to porous membrane 1 and the air flow rate through porous membrane 1 are measured based on the bubble point method. Next, in the coordinates in which the horizontal axis represents the differential pressure and the vertical axis represents the air flow rate, a fourth curve is obtained which indicates a relation between the differential pressure and the air flow rate. Next, a differential pressure P′ at the intersection between the third curve and the fourth curve is specified. Next, by dividing the product of a constant of 2860 and the surface tension of 16 mN/m of the fourth liquid by differential pressure P′, the mean flow pore diameter [nm] of porous membrane 1 is determined. It should be noted that in the bubble point method, for example, a perm porometer “CFP-1500A” provided by PMI is used as a pore diameter distribution measurement device.

### <<Crystallite>>

### <Structure of Crystallite>

Porous membrane 1 has a crystallite, and the crystallite has a length X along an MD direction of porous membrane 1 and a length Y along a TD direction of porous membrane 1. In the present disclosure, the “crystallite” means a portion of a minimum unit that can be regarded as a single crystal in a crystal grain. The upper limit of the length X along the MD direction of porous membrane 1 may be less than 60 nm. When the length X along the MD direction of porous membrane 1 is 60 nm or more, the average bubble point becomes small, with the result that the capturing performance for fine particles tends to be facilitated to be decreased. The upper limit of the length X along the MD direction of porous membrane 1 may be less than 59 nm or may be less than 58 nm. The lower limit of the length X along the MD direction of porous membrane 1 is not particularly limited, and can be, for example, 5 nm or more, 7 nm or more, or 10 nm or more. Further, in the present embodiment, the “MD direction” can be referred to as an elongation direction. In the present embodiment, the “TD direction” can be referred to as a direction perpendicular to the “MD direction” and the thickness direction of porous membrane 1.

The length X along the MD direction of porous membrane 1 can be specified by X-ray diffraction measurement. For the X-ray diffraction measurement, BL16 of the radiation facility SAGA-LS is used. In the beamline, monochromatization is performed to attain an X-ray wavelength of 0.124 nm by a double-crystal spectrometer using Si(111) diffraction. The measurement is performed by a transmission method, and a double-slit optical system is used with a NaI scintillation counter serving as a detector. Each of light receiving slits has a length (diffraction angle measurement direction) of 0.5 mm and a width (direction perpendicular to the diffraction angle measurement direction) of 3 mm. By using a peak integral width B1 of polytetrafluoroethylene (100) diffraction ray of the obtained XRD profile and θ1, which is ½ of a Bragg angle 2θ1 that is the peak position, the length X is calculated based on the Scherrer equation (the following formula 5) with a Scherrer constant of 1. λ1 means the wavelength of the X-ray and is 0.124 nm.

X=λ1/(B1 cosθ1) Formula 5

The upper limit of the length Y along the TD direction of porous membrane 1 may be less than 60 nm. When length Y along the TD direction of porous membrane 1 is 60 nm or more, the average bubble point becomes small (i.e., the capturing performance for fine particles becomes low), with the result that the permeation efficiency tends to be facilitated to be decreased. The upper limit of the length Y along the TD direction of porous membrane 1 may be less than 59 nm or may be less than 58 nm. The lower limit of the length Y along the TD direction of porous membrane 1 is not particularly limited, and may be, for example, 5 nm or more, 7 nm or more, or 10 nm or more.

The length Y along the TD direction of porous membrane 1 can be specified by X-ray diffraction measurement. For the X-ray diffraction measurement, 8116 of the radiation facility SAGA-LS is used. In the beamline, monochromatization is performed to attain an X-ray wavelength of 0.124 nm by a double-crystal spectrometer using Si(111) diffraction. The measurement is performed by a transmission method, and a double-slit optical system is used with a NaI scintillation counter serving as a detector. Each of light receiving slits has a length (diffraction angle measurement direction) of 0.5 mm and a width (direction perpendicular to the diffraction angle measurement direction) of 3 mm. The X-ray diffraction measurement is performed after measuring the “length X along the MD direction of porous membrane 1” as described above and then rotating porous membrane 1 by 90° along an imaginary plane perpendicular to the membrane thickness direction of porous membrane 1. By using a peak integral width B2 of polytetrafluoroethylene (100) diffraction ray of the obtained XRD profile and θ2, which is ½ of a Bragg angle “2×θ2” that is the peak position, the length Y is calculated based on the Scherrer equation (the following formula 6) with a Scherrer constant of 1. λ2 means the wavelength of the X-ray and is 0.124 nm.

Y=λ2/(B2 cosθ2) Formula 6

A product XY of the length X and the length Y may be less than 1200 nm². Thus, even when the fiber of the porous membrane becomes thin to result in a high fiber density, the porosity ratio is high, with the result that porous membrane 1 can have both a higher average bubble point and a lower Gurley second. The upper limit of the product XY of the length X and the length Y may be less than 1100 nm² or may be less than 1000 nm². The lower limit of the product XY of the length X and the length Y is not particularly limited, and can be, for example, 30 nm² or more, 50 nm² or more, or 100 nm² or more.

### <Composition of Crystallite>

The crystallite may consist of polytetrafluoroethylene. Thus, the crystallinity is high and the density of the crystallite of porous membrane 1 is facilitated to be high, with the result that porous membrane 1 can have both higher permeation efficiency and higher capturing performance for fine particles included in the filtrate. It should be noted that here, the expression “consist of polytetrafluoroethylene” is not limited to an embodiment in which the crystallite consists only of polytetrafluoroethylene, and represents a concept including an embodiment in which the crystallite includes a component (for example, an inevitable impurity) other than polytetrafluoroethylene as long as the effect of the present disclosure is exhibited.

### <<Method of Producing Porous Membrane>>

A method of producing the porous membrane according to the present embodiment includes: a first-1 step of obtaining a kneaded material of a polytetrafluoroethylene powder and a liquid lubricant; a first-2 step of obtaining a sheet-shaped molded body through extrusion molding of the kneaded material; a first-3 step of obtaining a stretched body by biaxially stretching the molded body; and a first-4 step of obtaining the porous membrane by performing heat treatment onto the stretched body. Moreover, the first-4 step is performed under a condition of less than 345° C.

### <First-1 Step>

The first-1 step is performed by kneading the polytetrafluoroethylene powder and the liquid lubricant to obtain the kneaded material. More specifically, first, the polytetrafluoroethylene powder and the liquid lubricant are mixed to obtain a mixture. Next, the mixture is subjected to compression molding to have a block shape by using a compression molding machine, thereby obtaining the kneaded material.

The polytetrafluoroethylene powder means a powder consisting of fine particles of polytetrafluoroethylene. Examples of the polytetrafluoroethylene powder include: a “PTFE (polytetrafluoroethylene) fine powder” produced by emulsion polymerization; a “PTFE molding powder” produced by suspension polymerization; and the like.

The number average molecular weight of the polytetrafluoroethylene in the polytetrafluoroethylene powder may be 12,000,000 or more and 50,000,000 or less from such a viewpoint that the pore diameter is excessively expanded during stretching and growth of a fibrous framework can be promoted while preventing cleavage of the porous membrane. Moreover, a second melting heat amount in the polytetrafluoroethylene powder may be 10 J/g or more and 25 J/g or less from such a viewpoint that it depends on the number average molecular weight in the polytetrafluoroethylene powder. Here, the second melting heat amount can be specified by the following method. The polytetrafluoroethylene powder is heated from a room temperature to 380° C. at a rate of 10° C./min (pattern 1 (1st. Run)), is then cooled from 380° C. to 100° C. at a rate of −1° C./min (pattern 2), and is then heated from 100° C. to 380° C. at a rate of 10° C./min (pattern 3 (2nd. Run)). An endothermic amount obtained by integrating an interval of 48° C. from an endset temperature of a peak of the melting curve of pattern 3 in a range of 300° C. or more and 360° C. or less is defined as the second melting heat amount.

As the liquid lubricant, various lubricants conventionally used in an extrusion method can be used. Examples of the liquid lubricant include: a petroleum-based solvent such as solvent naphtha or white oil; hydrocarbon oil such as undecane; an aromatic hydrocarbon such as toluol or xylol; an alcohol; a ketone; an ester; silicone oil; fluorochlorocarbon oil; a solution obtained by dissolving a polymer such as polyisobutylene or polyisoprene in each of these solvents, water or an aqueous solution including a surface active agent; and the like, and these may be used solely or in the form of a mixture of two or more thereof. However, from the viewpoint of uniformity of mixing, a liquid lubricant of a single component may be used.

The parts by mass of the liquid lubricant may be 10 parts by mass or more and 40 parts by mass or less with respect to 100 parts by mass of the polytetrafluoroethylene powder. When the parts by mass of the liquid lubricant is less than 10 parts by mass, it tends to be difficult to perform extrusion. When the mass of the liquid lubricant is more than 40 parts by mass, it tends to be difficult to perform compression molding.

In addition to the polytetrafluoroethylene powder and the liquid lubricant, another additive may be further used as a material of the kneaded material. Examples of the other additive include: a pigment for coloring; an inorganic filler, such as carbon black, graphite, silica powder, glass powder, glass fiber, a silicate, or a carbonate, a metal powder, a metal oxide powder, or a metal sulfide powder for changing wear resistance, preventing low-temperature flow, or facilitating pore formation; and the like. Moreover, in order to assist formation of a porous structure, a material to be removed or decomposed by heating, extraction, melting, or the like may be used in the form of a powder or a solution, such as ammonium chloride, sodium chloride, a plastic other than polytetrafluoroethylene, or a rubber,

### <First-2 Step>

The first-2 step is performed by performing extrusion-molding onto the kneaded material so as to obtain the sheet-shaped molded body. More specifically, the kneaded material is subjected to extrusion molding to have a sheet shape at a temperature of room temperature (for example, 25° C.) or more and 50° C. or less and at a rate of, for example, 10 mm/min or more and 30 mm/min or less, thereby obtaining a precursor of the sheet-shaped molded body. Further, the precursor is subjected to rolling with a calender roll or the like, thereby obtaining the sheet-shaped molded body having an average thickness of 0.250 mm or more and 0.400 mm or less. The average thickness can be specified in the same manner as the thickness of porous membrane 1 except that the measurement is performed onto the molded body.

Further, the liquid lubricant included in the molded body may be removed before the below-described first-3 step is performed. The liquid lubricant can be removed by performing heating, extraction, melting, or the like onto the molded body. When the heating is performed, for example, the liquid lubricant can be removed from the molded body by performing rolling onto the molded body using a hot roll of 130° C. or more and 220° C. or less. When a liquid lubricant having a relatively high boiling point such as silicone oil or fluorochlorocarbon oil is used as the liquid lubricant, the removal by extraction is preferable.

### <First-3 Step>

The first-3 step is performed by biaxially stretching the molded body so as to obtain the stretched body. Here, the biaxial stretching means stretching the sheet-shaped molded body in the MD direction (in other words, the flow direction of the molded body) and the TD direction orthogonal to the MD direction.

The temperature in the first-3 step may be 60° C. or more and 300° C. or less. When the temperature is more than 300° C., the pore diameter of the porous membrane tends to be too large (in other words, the average bubble point of the porous membrane tends to be too small). When the temperature is less than 60° C., the pore diameter tends to be too small (in other words, the average bubble point of the porous membrane tends to be too large). The average bubble point P1 and the product XY of the length X and the length Y can be adjusted to fall within the desired ranges by adjusting the temperature in the first-3 step to fall within the range of “60° C. or more and 300° C. or less”.

A draw ratio in the MD direction may be 1.5 times or more and 20 times or less. It should be noted that the draw ratio in the MD direction means a value obtained by dividing the average length in the MD direction immediately after the stretching in the MD direction by the average length in the MD direction immediately before the stretching in the MD direction. When the draw ratio in the MD direction is less than 1.5 times, the thickness of the porous membrane may fall out of the desired range. When the draw ratio in the MD direction is more than 20 times, the thickness of the porous membrane may fall out of the desired range. It should be noted that here, the “average length in the MD direction” means the average value of lengths at any ten locations in the MD direction.

The draw ratio in the TD direction may be 1.5 times or more and 100 times or less. It should be noted that the draw ratio in the TD direction means a value obtained by dividing the average length in the TD direction immediately after the stretching in the TD direction by the average length in the TD direction immediately before the stretching in the TD direction. When the draw ratio in the TD direction is less than 1.5 times, the thickness of the porous membrane may fall out of the desired range. When the draw ratio in the TD direction is more than 100 times, the thickness of the porous membrane may fall out of the desired range. It should be noted that here, the “average length in the TD direction” means the average value of lengths at any ten locations in the TD direction.

### <First-4 Step>>

The first-4 step is performed by performing heat treatment onto the stretched body so as to obtain the porous membrane. The first-4 step is performed under a condition of less than 345° C. Thus, the porous membrane can satisfy the relation of the above-described formula 1 or formula 2. Moreover, contraction of the porous membrane over time can be prevented. By adjusting the temperature of the heat treatment to fall within the range of “less than 345° C.” in the first-4 step, the Gurley second, the average bubble point, and the product XY of the length X and the length Y can be adjusted to fall within the respective desired ranges.

A time of the first-4 step may be 0.1 minute or more and 20 minutes or less. When the time is less than 0.1 minute, the contraction of the porous membrane over time tends to be less likely to be prevented. When the time is more than 20 minutes, the average bubble point of the porous membrane tends to be facilitated to be increased excessively. By adjusting the time of the first-4 step to fall within the range of “0.1 minute or more and 20 minutes or less”, the average bubble point and the product XY of the length X and the length Y can be adjusted to fall within the respective desired ranges.

In this way, it is possible to obtain a porous membrane including polytetrafluoroethylene as a main component, wherein the porous membrane has a Gurley second and an average bubble point, and the Gurley second and the average bubble point satisfy the relation of the above-described formula 1 or formula 2.

### Second Embodiment: Filter Element (1)

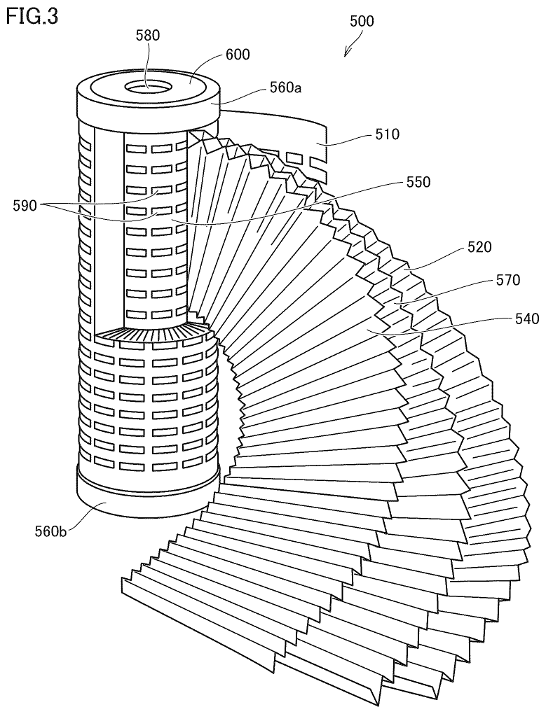

A filter element (1) according to one embodiment of the present disclosure will be described with reference to FIG. 3. A filter element 500 according to the present embodiment includes a porous membrane 570 according to the first embodiment.

Although filter element 500 according to the present embodiment is not particularly limited as long as filter element 500 includes porous membrane 570 according to the first embodiment, porous membrane 570 can have a pleated structure in filter element 500, for example.

According to the present disclosure, it is possible to provide a filter element including a porous membrane having both a high average bubble point and a low Gurley second.

FIG. 3 shows filter element 500 including porous membrane 570 having the pleated structure. Porous membrane 570 is pleated with porous membrane 570 being sandwiched between two protective members 520, 540, and is wound around a core 550 having a large number of liquid collection ports 590. On a side external thereto, an outer peripheral guard 510 is present and protects porous membrane 570. Porous membrane 570 is sealed by end plates 560a, 560b at both ends of the cylinder. Each of the end plates is in contact with a sealing portion of a filter housing (not shown) with a gasket 600 being interposed therebetween. A filtered liquid is collected via liquid collection ports 590 of core 550 and is recovered from an outlet 580. Regarding the filter element, there have been known a filter element having outlets at its both ends and a filter element having an outlet at one end. Generally, in the case of the filter element having the outlets at its both ends, one end thereof is sealed by a jig, thereby recovering the filtered liquid from the outlet at the other end.

### <<Method of Producing Filter Element (1)>>

A method of producing the filter element according to the present embodiment can be performed in the same manner as in a conventionally known method except that the porous membrane according to the first embodiment is used.

### Third Embodiment: Stacked Body

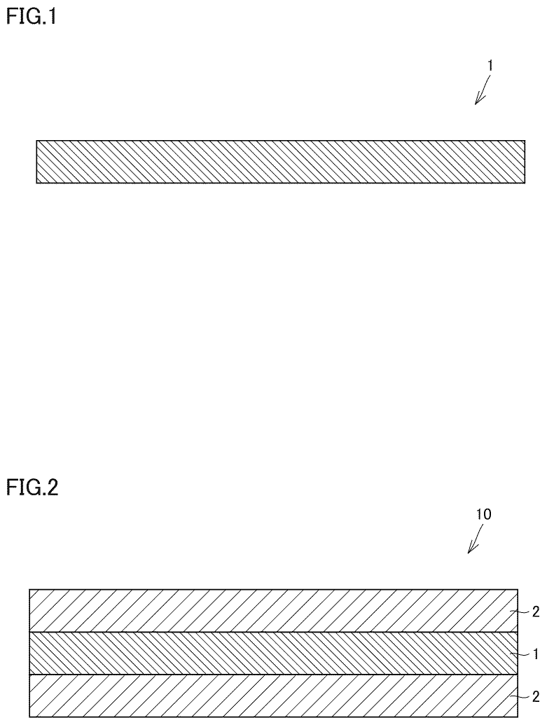

A stacked body 10 according to the present embodiment will be described with reference to FIG. 2.

Stacked body 10 according to the present embodiment is a stacked body 10 comprising: one or a plurality of porous membranes 1 according to the first embodiment; and a support membrane 2 located on one surface or each of both surfaces of at least one porous membrane 1 of porous membranes 1, wherein
support membrane 2 is porous,
support membrane 2 includes polytetrafluoroethylene as a main component, and
stacked body 10 has a Gurley second and an average bubble point.

In stacked body 10 according to the present embodiment, the Gurley second of stacked body 10 and the average bubble point of stacked body 10 satisfy a relation of the following formula 3 or formula 4:

G2<0.040×P2a Formula 3

G2<(0.025×P2b)−6 Formula 4

Thus, even when the fiber of the stacked body becomes thin to result in a high fiber density (in other words, even when the average bubble point of the stacked body becomes high), the porosity ratio is high. Therefore, with stacked body 10, an increased Gurley second due to the high average bubble point can be suppressed. As a result, porous membrane 1 can have both excellent capturing performance for fine particles and excellent permeation efficiency.

It should be noted that the average bubble point is measured by the bubble point method, and a specific liquid is used in the bubble point method. The numerical value of the average bubble point differs depending on a surface tension of the specific liquid. From the viewpoint of difficulty in obtaining the specific liquid, the formula 3 for the “P2a” measured by a bubble point method using a “second-a liquid” and the formula 4 for the “P2b” measured by a bubble point method using a “second-b liquid” are defined.

### <<Structure of Stacked Body>>

Stacked body 10 includes: the one or a plurality of porous membranes 1 according to the first embodiment; and support membrane 2 located on one surface or each of both surfaces of at least one porous membrane 1 of porous membranes 1. Thus, support membrane 2 functions as a protective member for porous membrane 1 according to the first embodiment, with the result that the capturing performance of stacked body 10 can be improved and the mechanical strength of stacked body 10 and the life of stacked body 10 can be improved.

The thickness of stacked body 10 may be 0.010 mm or more and 0.200 mm or less. When the thickness is less than 0.010 mm, the strength of stacked body 10 tends to be insufficient. When the thickness is more than 0.200 mm, pressure loss during permeation of the filtrate tends to be large. The lower limit of the thickness of stacked body 10 may be 0.010 mm or more, 0.013 mm or more, or 0.015 mm or more. The upper limit of the thickness of stacked body 10 may be 0.200 mm or less, 0.150 mm or less, or 0.100 mm or less. The thickness of stacked body 10 may be 0.013 mm or more and 0.150 mm or less, or may be 0.015 mm or more and 0.100 mm or less. The thickness of stacked body 10 can be specified in the same manner as in the method of measuring the thickness of porous membrane 1 except that the measurement is performed onto “stacked body 10”. It should be noted that it has been confirmed that the same results are obtained even when different measurement ranges are freely selected in the same stacked body 10 and the above-described measurement is performed in the measurement ranges.

### <<Density of Stacked Body>>

The density of stacked body 10 may be 0.10 g/cm³ or more and 2.00 g/cm³ or less. When the density is less than 0.10 g/cm³, the strength of stacked body 10 tends to be insufficient. When the density is more than 2.00 g/cm³, the permeation efficiency of stacked body 10 tends to be decreased. The lower limit of the density of stacked body 10 may be 0.10 g/cm³ or more, 0.13 g/cm³ or more, or 0.15 g/cm³ or more. The upper limit of the density of stacked body 10 may be 2.00 g/cm³ or less, 1.70 g/cm³ or less, or 1.50 g/cm³ or less. The density of stacked body 10 may be 0.13 g/cm³ or more and 1.70 g/cm³ or less, or may be 0.15 g/cm³ or more and 1.50 g/cm³ or less.

The density of stacked body 10 can be specified in the same manner as in the “method of measuring the density of porous membrane 1” as described in the first embodiment except that the measurement is performed onto “stacked body 10”. It should be noted that it has been confirmed that the same results are obtained even when different measurement ranges are freely selected in the same stacked body 10 and the above-described measurement is performed in the measurement ranges,

### <<Basis Weight of Stacked Body>>

The basis weight of stacked body 10 may be 0.005 mg/mm² or more and 0.100 mg/mm² or less. When the basis weight of stacked body 10 is less than 0.005 mg/mm², the strength of stacked body 10 tends to be insufficient. When the basis weight of stacked body 10 is more than 0.100 mg/mm², the permeation efficiency of stacked body 10 tends to be decreased. The lower limit of the basis weight of stacked body 10 may be 0.005 mg/mm² or more, 0.007 mg/mm² or more, or 0.008 mg/mm² or more. The upper limit of the basis weight of stacked body 10 may be 0.100 mg/mm² or less, 0.080 mg/mm² or less, or 0.060 mg/mm² or less. The basis weight of stacked body 10 may be 0.007 mg/mm² or more and 0.080 mg/mm² or less, or may be 0.008 mg/mm² or more and 0.060 mg/mm² or less.

The basis weight of stacked body 10 can be specified in the same manner as in the “method of measuring the basis weight of porous membrane 1” as described in the first embodiment except that the measurement is performed onto “stacked body 10”. It should be noted that it has been confirmed that the same results are obtained even when different measurement ranges are freely selected in the same stacked body 10 and the above-described measurement is performed in the measurement ranges.

### <<Average Bubble Point and Gurley Second>

### <Average Bubble Point>

Stacked body 10 has the average bubble point (P2a and P2b). The P2a may be 510 kPa or more. Thus, the fiber of the stacked body is formed to be thin and is densely formed, with the result that stacked body 10 can have both a higher average bubble point and a lower Gurley second. The lower limit of the P2a may be 510 kPa or more, 520 kPa or more, or 530 kPa or more. The upper limit of the P2a may be 1000 kPa or less, 990 kPa or less, or 980 kPa or less. The P2a may be 510 kPa or more and 1000 kPa or less, or may be 520 kPa or more and 990 kPa or less.

The P2b may be 1000 kPa or more. Thus, the fiber of stacked body 10 is formed to be thin and is densely formed, with the result that stacked body 10 can have both a higher average bubble point and a lower Gurley second. The lower limit of the P2b may be 1020 kPa or more, or 1040 kPa or more. The upper limit of the P2b may be 1600 kPa or less, 1500 kPa or less, or 1465 kPa or less. The P2b may be 1000 kPa or more and 1600 kPa or less, or may be 1020 kPa or more and 1500 kPa or less.

In stacked body 10, the P2a is measured by the bubble point method using the second-a liquid, and the surface tension of the second-a liquid is 13 mN/m. More specifically, in stacked body 10, the P2a is specified in the same manner as in the method of measuring the P1a except that the measurement is performed onto the “stacked body” and the name of the liquid “first-a liquid” is replaced with the “second-a liquid”.

In stacked body 10, the P2b is measured by the bubble point method using the second-b liquid, and the surface tension of the second-b liquid is 21 mN/m. More specifically, in porous membrane 1, the P2b is specified in the same manner as in the method of measuring the P1a except that isopropyl alcohol (second-b liquid) provided by FUJIFILM Wako Pure Chemical Corporation is used instead of the first-a liquid.

### <Gurley Second>

Stacked body 10 has the Gurley second (G2). In stacked body 10, the G2 may be 1 second or more and 100 seconds or less. Thus, the flow rate of the filtrate can be high, with the result that the permeation efficiency can be high and the capturing performance for fine particles included in the filtrate can be high. The lower limit of the G2 may be 1 second or more, 3 seconds or more, or 5 seconds or more. The upper limit of the G2 may be 100 seconds or less, 80 seconds or less, or 70 seconds or less. The G2 may be 3 seconds or more and 80 seconds or less, or may be 5 seconds or more and 70 seconds or less.

In stacked body 10, the G2 is specified by the following method. The G2 can be specified in the same manner as in the “method of measuring the G1 of porous membrane 1” in the first embodiment except that the measurement is performed onto the “stacked body”.

### <Relation Between Gurley Second and Average Bubble Point>

The Gurley second of stacked body 10 and the average bubble point of stacked body 10 satisfy the relation of the following formula 3 or formula 4:

G2<0.040×P2a Formula 3

G2<(0.025×P2b)−6 Formula 4

In each of the formula 3 and the formula 4, the G2 represents the Gurley second of stacked body 10,
in the formula 3, the P2a represents the average bubble point of stacked body 10,
the P2a is measured by the bubble point method using the second-a liquid,
the surface tension of the second-a liquid is 13 mN/m,
in the formula 4, the P2b is the average bubble point of stacked body 10,
the P2b is measured by the bubble point method using the second-b liquid, and
the surface tension of the second-b liquid is 21 mN/m.

Thus, stacked body 10 can have both a high average bubble point and a low Gurley second, and therefore can have both excellent capturing performance for fine particles and excellent permeation efficiency. It should be noted that in the formula 3, “0.040” means a slope in the linear function. In the formula 4, “0.025” means a slope in the linear function, and “−6” means an intercept in the linear function.

### <<Mean Flow Pore Diameter>>

The mean flow pore diameter of stacked body 10 may be 25 nm or more and 100 nm or less. Thus, stacked body 10 can have both higher permeation efficiency and higher capturing performance for fine particles included in the filtrate. The lower limit of the mean flow pore diameter may be 25 nm or more, 26 nm or more, or 27 nm or more. The upper limit of the mean flow pore diameter may be 100 nm or less, 60 nm or less, or 55 nm or less. The mean flow pore diameter may be 26 nm or more and 60 nm or less, or may be 27 nm or more and 55 nm or less.

The mean flow pore diameter of stacked body 10 can be specified in the same manner as in the “method of measuring the mean flow pore diameter of porous membrane 1” in the first embodiment except that the measurement is performed onto “stacked body 10”.

### <<Support Membrane>>

### <Structure of Support Membrane>

Support membrane 2 is porous. Here, “porous” means inclusion of a fibrous framework in which pores are connected in the form of a three-dimensional mesh. Support membrane 2 has a pore diameter larger than that of the porous membrane, and may not inhibit the permeation efficiency. The fact “support membrane 2 is porous” can be specified by observing a surface and any cross section of support membrane 2 using a scanning electron microscope.

The thickness of support membrane 2 may be 0.002 mm or more and 0.050 mm or less. When the thickness of support membrane 2 is less than 0.002 mm, the function as a protective member for porous membrane 1 tends to be less likely to be exhibited, and the mechanical strength of stacked body 10 and the life of stacked body 10 tend to be less likely to be increased. When the thickness of support membrane 2 is more than 0.050 mm, both the capturing performance of stacked body 10 and the permeation efficiency of stacked body 10 tend to be less likely to be achieved by porous membrane 1. The lower limit of the thickness may be 0.002 mm or more, 0.004 mm or more, or 0.006 mm or more. The upper limit of the thickness may be 0.050 mm or less, 0.045 mm or less, or 0.040 mm or less. The thickness may be 0.004 mm or more and 0.045 mm or less, or may be 0.006 mm or more and 0.040 mm or less.

The thickness of support membrane 2 can be specified in the same manner as in the method of measuring the “thickness of porous membrane 1” as described in the first embodiment except that the measurement is performed onto support membrane 2. It should be noted that it has been confirmed that the same results are obtained even when different measurement ranges are freely selected in the same support membrane 2 and the above-described measurement is performed in the measurement ranges.

### <Density of Support Membrane>

The density of support membrane 2 may be 0.10 g/cm³ or more and 2.00 g/cm³ or less. When the density is less than 0.10 g/cm³, the strength of stacked body 10 tends to be insufficient. When the density is more than 2.00 g/cm³, the permeation efficiency of stacked body 10 tends to be decreased. The lower limit of the density of support membrane 2 may be 0.10 g/cm³ or more, 0.13 g/cm³ or more, or 0.15 g/cm³ or more. The upper limit of the density of support membrane 2 may be 2.00 g/cm³ or less, 1.70 g/cm³ or less, or 1.50 g/cm³ or less. The density of support membrane 2 may be 0.13 g/cm³ or more and 1.70 g/cm³ or less, or may be 0.15 g/cm³ or more and 1.50 g/cm³ or less.

The density of support membrane 2 can be specified in the same manner as in the method of measuring the density of porous membrane 1 except that the measurement is performed onto “support membrane 2”. It should be noted that it has been confirmed that the same results are obtained even when different measurement ranges are freely selected in the same support membrane 2 and the above-described measurement is performed in the measurement ranges.

### <Basis Weight of Support Membrane>

The basis weight of support membrane 2 may be 0.005 mg/mm² or more and 0.100 mg/mm² or less. When the basis weight of support membrane 2 is less than 0.005 mg/mm², the strength of stacked body 10 tends to be insufficient. When the basis weight of support membrane 2 is more than 0.100 mg/mm², the permeation efficiency of stacked body 10 tends to be decreased. The lower limit of the basis weight of support membrane 2 may be 0.005 mg/mm² or more, 0.006 mg/mm² or more, or 0.007 mg/mm² or more. The upper limit of the basis weight of support membrane 2 may be 0.100 mg/mm² or less, 0.080 mg/mm² or less, or 0.060 mg/mm² or less. The basis weight of support membrane 2 may be 0.006 mg/mm² or more and 0.080 mg/mm² or less, or may be 0.007 mg/mm² or more and 0.060 mg/mm² or less.

The basis weight of support membrane 2 can be specified by the following method. The basis weight of support membrane 2 can be specified in the same manner as in the method of measuring the basis weight of porous membrane 1 except that the measurement is performed onto “support membrane 2”. It should be noted that it has been confirmed that the same results are obtained even when different measurement ranges are freely selected in the same support membrane 2 and the above-described measurement is performed in the measurement ranges.

### <Average Bubble Point and Gurley Second>

### <Average Bubble Point>

The average bubble point P3a of support membrane 2 may be 5 kPa or more and 400 kPa or less, or the average bubble point P3b of support membrane 2 may be 5 kPa or more and 800 kPa or less. Thus, the fiber of support membrane 2 is formed to be thin and is densely formed, with the result that stacked body 10 can have both a higher average bubble point and a lower Gurley second.

It should be noted that the average bubble point is measured by the bubble point method, and a specific liquid is used in the bubble point method. The numerical value of the average bubble point differs depending on a surface tension of the specific liquid. From the viewpoint of difficulty in obtaining the specific liquid, the “P3a” measured by a bubble point method using a “third-a liquid” described later and the “P3b” measured by a bubble point method using a “third-b liquid” described later are defined.

The average bubble point P3a of support membrane 2 may be 5 kPa or more and 400 kPa or less. Thus, the fiber of support membrane 2 is formed to be thin and is densely formed, with the result that stacked body 10 can have both a higher average bubble point and a lower Gurley second. The lower limit of the P3a may be 5 kPa or more, 7 kPa or more, or 10 kPa or more. The upper limit of the P3a may be 400 kPa or less, 350 kPa or less, or 300 kPa or less. The P3a may be 7 kPa or more and 350 kPa or less, or may be 10 kPa or more and 300 kPa or less.

The average bubble point P3b of support membrane 2 may be 5 kPa or more and 800 kPa or less. Thus, the fiber of support membrane 2 is formed to be thin and is densely formed, with the result that stacked body 10 can have both a higher average bubble point and a lower Gurley second. The lower limit of the P3b may be 5 kPa or more, 7 kPa or more, or 10 kPa or more. The upper limit of the P3b may be 800 kPa or less, 700 kPa or less, or 600 kPa or less. The P3b may be 7 kPa or more and 700 kPa or less, or may be 10 kPa or more and 600 kPa or less.

In support membrane 2, the P3a is measured by the bubble point method using the third-a liquid, and the surface tension of the third-a liquid is 13 mN/m. More specifically, in support membrane 2, the P3a is specified in the same manner as in the method of measuring the P1a except that the measurement is performed onto “support membrane 2” and the name of the liquid “first-a liquid” is replaced with the “third-a liquid”.

In support membrane 2, the P3b is measured by the bubble point method using the third-b liquid, and the surface tension of the third-b liquid is 21 mN/m. More specifically, in support membrane 2, the P3b is specified in the same manner as in the method of measuring the P1a except that the measurement is performed onto “support membrane 2” and isopropyl alcohol (third-b liquid) provided by FUJIFILM Wako Pure Chemical Corporation is used instead of the first-a liquid.

### <Gurley Second>

Support membrane 2 has the Gurley second (G3). In support membrane 2, the G3 may be 0.5 second or more and 60 seconds or less. Thus, the flow rate of the filtrate can be high, with the result that the permeation efficiency can be high and the capturing performance for fine particles included in the filtrate can be high. The lower limit of the G3 may be 0.5 second or more, 0.7 second or more, or 1.0 second or more. The upper limit of the G3 may be 60 seconds or less, 50 seconds or less, or 40 seconds or less. The G3 may be 0.7 second or more and 50 seconds or less, or may be 1.0 second or more and 40 seconds or less.

In support membrane 2, the G3 is specified by the following method. The G3 can be specified in the same manner as in the “method of measuring the G1 of porous membrane 1” in the first embodiment except that the measurement is performed onto “support membrane 2”.

### <Mean Flow Pore Diameter>

The mean flow pore diameter of support membrane 2 may be 45 nm or more and 600 nm or less. Thus, stacked body 10 can have both higher permeation efficiency and higher capturing performance for fine particles included in the filtrate. The lower limit of the mean flow pore diameter may be 45 nm or more, 50 nm or more, or 55 nm or more. The upper limit of the mean flow pore diameter may be 600 nm or less, 550 nm or less, or 500 nm or less. The mean flow pore diameter may be 50 nm or more and 550 nm or less, and may be 55 nm or more and 500 nm or less.

The mean flow pore diameter of support membrane 2 can be specified by the following measurement method. The mean flow pore diameter of support membrane 2 can be specified in the same manner as in the “method of measuring the mean flow pore diameter of porous membrane 1” in the first embodiment except that the measurement is performed onto “support membrane 2”.

### <Composition of Support Membrane>

Support membrane 2 includes polytetrafluoroethylene as a main component. Thus, the heat resistance, chemical stability, and the like of support membrane 2 can be improved. It should be noted that here, the “main component” means a component having the largest content in terms of mass, such as a component having a content of 90 mass % or more, preferably 95 mass % or more. Support membrane 2 may consist of polytetrafluoroethylene. It should be noted that the expression “support membrane 2 consists of polytetrafluoroethylene” means that support membrane 2 can include an inevitable impurity as long as the effect of the present disclosure is exhibited.

The content of polytetrafluoroethylene in support membrane 2 can be specified in the same manner as in the method of measuring “the content of polytetrafluoroethylene in porous membrane 1” as described in the first embodiment except that the measurement is performed onto support membrane 2. It should be noted that it has been confirmed that the same results are obtained even when different measurement ranges are freely selected in the same support membrane 2 and the above-described measurement is performed in the measurement ranges.

### <<Method of Producing Stacked Body>>

A method of producing the stacked body includes: a second-1 step of preparing the porous membrane according to the first embodiment and the support membrane;

and a second-2 step of stacking the porous membrane on the support membrane. The second-1 step consists of: a second-1-a step of preparing the porous membrane; and a second-1-b step of preparing the support membrane.

### <Second-1 Step>

### (Second-1-a Step)

The second-1-a step is performed by preparing the porous membrane. Porous membrane 1 can be prepared by the method described in the first embodiment.

### (Second-1-b Step)

The second-1-b step is performed by preparing the support membrane. The support membrane can be prepared by a conventionally known method.

### <Second-2 Step>

The second-2 step is performed by stacking the porous membrane on one surface or each of both surfaces of the support membrane. Examples of a method of stacking the porous membrane on one surface or each of both surfaces of the support membrane include a method of performing pressure bonding onto the support membrane and the porous membrane.

Specifically, as the method of performing pressure bonding onto the support membrane and the porous membrane, for example, first, the support membrane and the porous membrane are overlapped with each other so as to obtain a stacked body precursor. Next, the stacked body precursor is pressed by flat plates from above and below, or the stacked body precursor is sandwiched between rotation rollers from above and below and is then sent out. The method of performing pressure bonding onto the support membrane and the porous membrane is performed by performing the pressure bonding at 100 kgf or more and 700 kgf or less. When the force is less than 100 kgf, adhesive force between the support membrane and the porous membrane tends to be insufficient. When the force is more than 700 kgf, the pores of the support membrane and the porous membrane are collapsed, with the result that the permeation efficiency tends to be facilitated to be decreased.

In this way, it is possible to obtain a stacked body 10 comprising: one or a plurality of the porous membranes according to the first embodiment; and a support membrane 2 located on one surface or each of both surfaces of at least one porous membrane of the porous membranes, wherein the support membrane is porous, support membrane 2 includes polytetrafluoroethylene as a main component, stacked body 10 has a Gurley second and an average bubble point, and the Gurley second of the stacked body and the average bubble point of the stacked body satisfy the relation of the above-described formula 3 or formula 4.

### Fourth Embodiment: Filter Element (2)

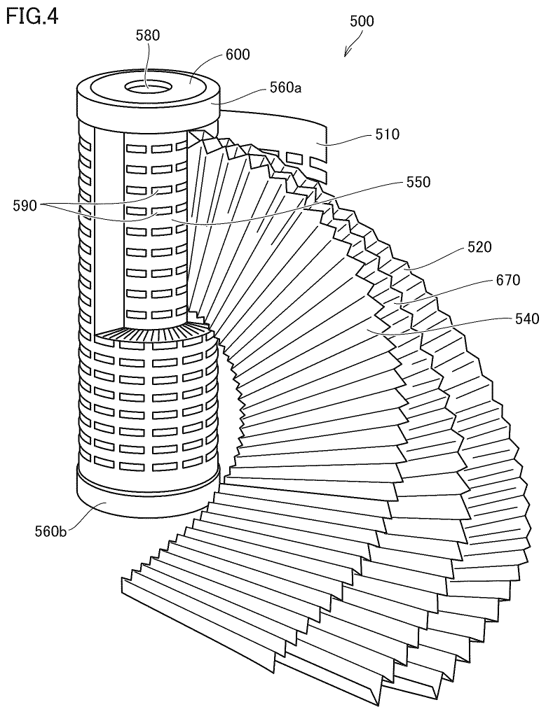

A filter element (2) according to one embodiment of the present disclosure will be described with reference to FIG. 4. A filter element 500 according to the present embodiment includes stacked body 670 according to the third embodiment. Although filter element 500 according to the present embodiment is not particularly limited as long as filter element 500 includes stacked body 670 according to the third embodiment, stacked body 670 can have a pleated structure in filter element 500, for example.

According to the present disclosure, it is possible to provide a filter element including a stacked body having both a high average bubble point and a low Gurley second.

FIG. 4 shows filter element 500 including stacked body 670 having the pleated structure. The structure of filter element 500 in FIG. 4 is the same as the structure of filter element 500 in FIG. 3 except that porous membrane 570 is replaced with stacked body 670.

### <<Method of Producing Filter Element (2)>>

A method of producing the filter element according to the present embodiment can be performed in the same manner as in a conventionally known method except that the stacked body according to the third embodiment is used.

### EXAMPLES

Hereinafter, explanation will be specifically made based on examples of the present disclosure, but the present invention is not limited to the following examples.

### Example 1

### <<Production of Porous Membrane>

In an Example 1, each of porous membranes according to samples 1-1 to 1-8 and samples 1-101 to 1-105 was produced in the following manner.

### <First-1 Step>

First, a “PTFE fine powder A (second melting heat amount of 15.8 J/g; molecular weight of about 28,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 1, thereby obtaining a mixture. Next, the mixture was subjected to compression molding to have a block shape by using a compression molding machine, thereby obtaining a kneaded material.

### <First-2 Step>

The kneaded material was subjected to extrusion molding to have a sheet shape under conditions described in Table 1, thereby obtaining a precursor of a sheet-shaped molded body. Next, the precursor was subjected to rolling with a calender roll, thereby obtaining the sheet-shaped molded body having an average thickness as shown in Table 1.

### <First-3 Step>

The molded body was biaxially stretched under conditions described in Table 1, thereby obtaining a stretched body.

### <First-4 Step>

The stretched body was subjected to heat treatment under conditions described in Table 1, thereby obtaining the porous membrane.

In this way, the porous membranes according to samples 1-1 to 1-8 and samples 1-101 to 1-105 were produced.

TABLE 1

| | | | First-2 Step | | | First-3 Step | | | | | |
|---|---|---|---|---|---|---|---|---|---|---|---|
| | First-1 Step | | | | Average | | | | | | |
| | PTFE | Liquid | Extrusion Molding | | Thickness | MD Direction | | TD Direction | | First-4 Step | |
| | Powder | Lubricant | | Rate | of Molded | | Draw | | Draw | Heat Treatment | |
| Sample | [Parts | [Parts | Temperature | [mm/ | Body | Temperature | Ratio | Temperature | Ratio | Temperature | Time |
| No. | by Mass] | by Mass] | [° C.] | min] | [μm] | [° C.] | [times] | [° C.] | [times] | [° C.] | [min] |
| 1-1 | 100 | 14 | 50 | 20 | 320 | 280 | 5.2 | 140 | 27 | 140 | 0.4 |
| 1-2 | 100 | 14 | 50 | 20 | 320 | 280 | 8.0 | 140 | 27 | 295 | 0.4 |
| 1-3 | 100 | 15 | 50 | 20 | 320 | 280 | 8.0 | 140 | 27 | 210 | 0.4 |
| 1-4 | 100 | 15 | 50 | 20 | 380 | 280 | 8.0 | 140 | 27 | 210 | 0.4 |
| 1-5 | 100 | 15 | 50 | 20 | 360 | 280 | 6.0 | 140 | 26 | 210 | 0.4 |
| 1-6 | 100 | 15 | 50 | 20 | 360 | 280 | 6.0 | 140 | 27 | 210 | 0.4 |
| 1-7 | 100 | 15 | 50 | 20 | 360 | 280 | 6.0 | 140 | 25 | 210 | 0.4 |
| 1-8 | 100 | 16 | 50 | 20 | 320 | 280 | 8.0 | 140 | 54 | 210 | 0.4 |
| 1-101 | 100 | 14 | 50 | 20 | 320 | 280 | 5.2 | 140 | 27 | 360 | 0.8 |
| 1-102 | 100 | 14 | 50 | 20 | 320 | 280 | 8.0 | 140 | 27 | 360 | 0.9 |
| 1-103 | 100 | 16 | 50 | 20 | 360 | 280 | 8.0 | 140 | 27 | 360 | 0.4 |
| 1-104 | 100 | 16 | 50 | 20 | 360 | 280 | 8.0 | 140 | 27 | 380 | 30 |
| 1-105 | 100 | 22 | 50 | 20 | 580 | 280 | 2.3 | 140 | 27 | 360 | 0.8 |

TABLE 2

| | PTFE | | Basis | | | | | Mean Flow |
|---|---|---|---|---|---|---|---|---|
| Sample | Content | Thickness | Weight | Density | X | Y | XY | Pore Diameter |
| No. | [mass %] | [mm] | [mg/mm²] | [g/cm³] | [nm] | [nm] | [nm²] | [nm] |
| 1-1 | 100 | 0.027 | 0.0098 | 0.360 | 32.0 | 34.2 | 1094 | 35 |
| 1-2 | 100 | 0.026 | 0.0067 | 0.257 | 35.4 | 33.6 | 1189 | 40 |
| 1-3 | 100 | 0.031 | 0.0086 | 0.277 | 34.0 | 33.2 | 1129 | 39 |
| 1-4 | 100 | 0.040 | 0.0114 | 0.286 | 30.1 | 27.2 | 819 | 25 or less |
| 1-5 | 100 | 0.036 | 0.0100 | 0.279 | 31.8 | 30.0 | 954 | 27 |
| 1-6 | 100 | 0.030 | 0.0082 | 0.274 | 32.8 | 31.6 | 1036 | 31 |
| 1-7 | 100 | 0.047 | 0.0130 | 0.276 | 29.8 | 28.0 | 834 | 25 or less |
| 1-8 | 100 | 0.006 | 0.0036 | 0.602 | 35.2 | 34.0 | 1197 | 52 |
| 1-101 | 100 | 0.008 | 0.0105 | 1.308 | 41.1 | 34.0 | 1397 | 59 |
| 1-102 | 100 | 0.007 | 0.0065 | 0.886 | 41.5 | 34.6 | 1436 | 59 |
| 1-103 | 100 | 0.007 | 0.0079 | 1.122 | 43.2 | 28.1 | 1214 | 53 |
| 1-104 | 100 | 0.015 | 0.0191 | 1.270 | 41.2 | 39.2 | 1615 | 106 |
| 1-105 | 100 | 0.013 | 0.0144 | 1.107 | 43.2 | 39.4 | 1702 | 72 |

TABLE 3

| | | | | | G1 − | | G1 − |
|---|---|---|---|---|---|---|---|
| Sample | P1a | P1b | G1 | 0.035 × | (0.035 × | 0.020 × | (0.020 × |
| No. | [kPa] | [kPa] | [s] | P1a | P1a) | P1b | P1b) |
| 1-1 | 670 | 1232 | 20 | 23 | −3 | 25 | −5 |
| 1-2 | 604 | 1108 | 18 | 21 | −3 | 22 | −4 |
| 1-3 | 623 | 1140 | 16 | 22 | −6 | 23 | −7 |
| 1-4 | 854 | 1549 | 27 | 30 | −3 | 31 | −4 |
| 1-5 | 705 | 1296 | 24 | 25 | −1 | 26 | −2 |
| 1-6 | 676 | 1282 | 21 | 24 | −3 | 26 | −5 |
| 1-7 | 825 | 1515 | 26 | 29 | −3 | 30 | −4 |
| 1-8 | 452 | 901 | 15 | 16 | −1 | 18 | −3 |
| 1-101 | 440 | 721 | 38 | 15 | 23 | 14 | 24 |
| 1-102 | 375 | 771 | 29 | 13 | 16 | 15 | 14 |
| 1-103 | 447 | 885 | 35 | 16 | 19 | 18 | 17 |
| 1-104 | 200 | 480 | 17 | 7 | 10 | 10 | 7 |
| 1-105 | 245 | 551 | 21 | 9 | 12 | 11 | 10 |

### <<Evaluation on Properties of Porous Membrane>>

For the porous membrane of each sample, the content of polytetrafluoroethylene, thickness, basis weight, density, crystallite structure, mean flow pore diameter, average bubble point, and Gurley second were determined by the methods described in the first embodiment. The obtained results are shown in Tables 2 and 3. When the P1a and the P1b are relatively high, it means that the capturing performance for fine particles is relatively excellent. When the Gurley second is relatively low, it means that the permeation efficiency is relatively excellent.

### <Capturing Performance for Fine Particles and Permeation Efficiency>

Each of the porous membranes according to samples 1-1 to 1-8 corresponds to an example of the present disclosure. On the other hand, each of the porous membranes according to samples 1-101 to 1-105 corresponds to a comparative example. Each of the porous membranes according to samples 1-1 to 1-8, each of which satisfies the relation of the formula 1 or the formula 2, has much more excellent “capturing performance for fine particles” than that of each of the porous membranes according to samples 1-101 to 1-105, each of which does not satisfy the relation of the formula 1 or the formula 2. Moreover, each of the porous membranes according to samples 1-1 to 1-8, each of which satisfies the relation of the formula 1 or the formula 2, has much more excellent permeation efficiency than that of each of the porous membranes according to samples 1-101 to 1-103, each of which does not satisfy the relation of the formula 1 or the formula 2. That is, each of the porous membranes according to samples 1-1 to 1-8, each of which satisfies the relation of the formula 1 or the formula 2, can exhibit such a particularly excellent effect that each of the porous membranes according to samples 1-1 to 1-8 has both excellent “capturing performance for fine particles” and excellent permeation efficiency as compared with each of the porous membranes according to samples 1-101 to 1-105, each of which does not satisfy the relation of the formula 1 or the formula 2.

In view of the above, it was found that each of the porous membranes according to samples 1-1 to 1-8 can exhibit such a particularly excellent effect that the porous membrane has both excellent “capturing performance for fine particles” and excellent permeation efficiency.

### Example 2

### <<Production of Stacked Body>>

In an Example 2, each of stacked bodies according to samples 2-1 to 2-5 and samples 2-101 to 2-105 was produced in the following manner.

### <Second-1-a Step>

One porous membrane was prepared for each sample in the following manner. First, a “PTFE fine powder A (second melting heat amount of 15.8 J/g; a molecular weight of about 28,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 4, thereby obtaining a mixture. Next, the mixture was subjected to compression molding to have a block shape by using a compression molding machine, thereby obtaining a kneaded material

The kneaded material was subjected to extrusion molding to have a sheet shape under conditions shown in Table 4, thereby obtaining a precursor of a sheet-shaped molded body. Next, the precursor was subjected to rolling with a calender roll, thereby obtaining the sheet-shaped molded body having an average thickness as shown in Table 4.

The molded body was biaxially stretched under conditions shown in Table 4, thereby obtaining a stretched body.

The stretched body was subjected to heat treatment under conditions shown in Table 4, thereby obtaining the porous membrane.

In this way, the porous membranes according to samples 2-1 to 2-5 and samples 2-101 to 2-105 were prepared.

### <Second-1-b Step>

Two support membranes were prepared for each sample in the following manner. First, a “PTFE fine powder B (second melting heat amount of 26.0 J/g; molecular weight of about 5,000,000)”, which is a polytetrafluoroethylene powder, and “Supersol FP-25” (trademark), which is a solvent naphtha (liquid lubricant) provided by Idemitsu Sekiyu, were mixed in parts by mass shown in Table 5, thereby obtaining a mixture. Next, the mixture was subjected to compression molding to have a block shape by using a compression molding machine, thereby obtaining a kneaded material.

The kneaded material was subjected to extrusion molding to have a sheet shape under conditions shown in Table 5, thereby obtaining a precursor of a sheet-shaped molded body. Next, the precursor was subjected to rolling with a calender roll, thereby obtaining the sheet-shaped molded body having an average thickness as shown in Table 5.

The molded body was biaxially stretched under conditions shown in Table 5, thereby obtaining a stretched body.

The stretched body was subjected to heat treatment under conditions shown in Table 5, thereby obtaining the support membrane, which is porous.

In this way, the support membranes according to samples 2-1 to 2-5 and samples 2-101 to 2-105, each of which is porous, were prepared.

### <Second-2 Step>

The support membranes and the porous membrane were stacked in the order of the support membrane, the porous membrane, and the support membrane under conditions shown in Table 6, thereby obtaining a stacked body.

In this way, each of stacked bodies according to samples 2-1 to 2-5 and samples 2-101 to 2-105 was produced.

TABLE 4

| | Second-1-a Step | | | | | | | | | | |
|---|---|---|---|---|---|---|---|---|---|---|---|
| | PTFE | Liquid | Extrusion Molding | | Average | MD Direction | | TD Direction | | | |
| | Powder | Lubricant | | Rate | Thickness | | Draw | | Draw | Heat Treatment | |
| Sample | [Parts | [Parts | Temperature | [mm/ | of Molded | Temperature | Ratio | Temperature | Ratio | Temperature | Time |
| No. | by Mass] | by Mass] | [° C.] | min] | Body [μm] | [° C.] | [times] | [° C.] | [times] | [° C.] | [min] |
| 2-1 | 100 | 14 | 50 | 20 | 320 | 280 | 5.2 | 140 | 27 | 140 | 0.4 |
| 2-2 | 100 | 14 | 50 | 20 | 320 | 280 | 8.0 | 140 | 27 | 140 | 0.4 |
| 2-3 | 100 | 14 | 50 | 20 | 320 | 280 | 8.0 | 140 | 27 | 295 | 0.4 |
| 2-4 | 100 | 16 | 50 | 20 | 320 | 280 | 8.0 | 140 | 27 | 210 | 0.8 |
| 2-5 | 100 | 14 | 50 | 20 | 320 | 280 | 5.2 | 140 | 54 | 140 | 0.4 |
| 2-101 | 100 | 14 | 50 | 20 | 320 | 280 | 8.0 | 140 | 27 | 360 | 0.8 |
| 2-102 | 100 | 14 | 50 | 20 | 320 | 280 | 8.0 | 140 | 27 | 360 | 0.8 |
| 2-103 | 100 | 14 | 50 | 20 | 320 | 280 | 5.2 | 140 | 27 | 380 | 30 |
| 2-104 | 100 | 14 | 50 | 20 | 320 | 280 | 5.2 | 140 | 27 | 140 | 0.4 |
| 2-105 | 100 | 16 | 50 | 20 | 320 | 280 | 8.0 | 140 | 27 | 210 | 0.4 |

TABLE 5

| | Second-1-b Step | | | | | | | | | | |
|---|---|---|---|---|---|---|---|---|---|---|---|
| | PTFE | Liquid | Extrusion Molding | | Average | MD Direction | | TD Direction | | | |
| | Powder | Lubricant | | Rate | Thickness | | Draw | | Draw | Heat Treatment | |
| Sample | [Parts | [Parts | Temperature | [mm/ | of Molded | Temperature | Ratio | Temperature | Ratio | Temperature | Time |
| No. | by Mass] | by Mass] | [° C.] | min] | Body [μm] | [° C.] | [times] | [° C.] | [times] | [° C.] | [min] |
| 2-1 | 100 | 23 | 50 | 20 | 260 | 280 | 3 | 150 | 21 | 390 | 0.8 |
| 2-2 | 100 | 23 | 50 | 20 | 260 | 280 | 3 | 150 | 21 | 390 | 0.8 |
| 2-3 | 100 | 23 | 50 | 20 | 260 | 280 | 3 | 150 | 21 | 390 | 0.8 |
| 2-4 | 100 | 23 | 50 | 20 | 260 | 280 | 3 | 150 | 21 | 390 | 0.8 |
| 2-5 | 100 | 23 | 50 | 20 | 260 | 280 | 3 | 150 | 21 | 390 | 0.8 |
| 2-101 | 100 | 23 | 50 | 20 | 260 | 280 | 3 | 150 | 21 | 390 | 0.8 |
| 2-102 | 100 | 23 | 50 | 20 | 260 | 280 | 3 | 150 | 21 | 390 | 0.8 |
| 2-103 | 100 | 23 | 50 | 20 | 260 | 280 | 3 | 150 | 21 | 390 | 0.8 |
| 2-104 | 100 | 23 | 50 | 20 | 260 | 280 | 3 | 150 | 21 | 390 | 0.8 |
| 2-105 | 100 | 23 | 50 | 20 | 260 | 280 | 3 | 150 | 21 | 390 | 0.8 |

TABLE 6

| | Second-2 Step |
|---|---|
| | Pressure Bonding |
| Sample No. | Force [kgf] |
| 2-1 | 100 |
| 2-2 | 100 |
| 2-3 | 100 |
| 2-4 | 600 |
| 2-5 | 200 |
| 2-101 | 400 |
| 2-102 | 500 |
| 2-103 | 200 |
| 2-104 | 50 |
| 2-105 | 1000 |

TABLE 7

| | Porous Membrane | | | | | | | |
|---|---|---|---|---|---|---|---|---|
| | PTFE | | Basis | | | | | Mean Flow |
| Sample | Content | Thickness | Weight | Density | X | Y | XY | Pore Diameter |
| No. | [mass %] | [mm] | [mg/mm²] | [g/cm³] | [nm] | [nm] | [nm²] | [nm] |
| 2-1 | 100 | 0.018 | 0.0025 | 0.360 | 32.0 | 34.2 | 1094 | 35 |
| 2-2 | 100 | 0.024 | 0.0094 | 0.392 | 33.8 | 32.1 | 1085 | 40 |
| 2-3 | 100 | 0.016 | 0.0041 | 0.257 | 35.4 | 33.6 | 1189 | 40 |
| 2-4 | 100 | 0.002 | 0.0012 | 0.602 | 35.2 | 33.8 | 1190 | 52 |
| 2-5 | 100 | 0.010 | 0.0029 | 0.293 | 34.0 | 33.4 | 1136 | 52 |
| 2-101 | 100 | 0.008 | 0.0080 | 0.999 | 43.4 | 35.0 | 1519 | 59 |
| 2-102 | 100 | 0.005 | 0.0044 | 0.886 | 43.2 | 34.6 | 1495 | 57 |
| 2-103 | 100 | 0.007 | 0.0089 | 1.270 | 41.2 | 39.2 | 1615 | 106 |
| 2-104 | 100 | 0.025 | 0.0090 | 0.360 | 32.0 | 34.2 | 1094 | 35 |
| 2-105 | 100 | 0.006 | 0.0036 | 0.602 | 35.2 | 34.0 | 1197 | 52 |

TABLE 8

| | Porous Membrane | | | | | | |
|---|---|---|---|---|---|---|---|
| | | | | | G1 − | | G1 − |
| Sample | P1a | P1b | G1 | 0.035 × | (0.035 × | 0.020 × | (0.020 × |
| No. | [kPa] | [kPa] | [s] | P1a | P1a) | P1b | P1b) |
| 2-1 | 670 | 1232 | 20 | 23 | −3 | 25 | −5 |
| 2-2 | 644 | 1198 | 22 | 23 | −1 | 24 | −2 |
| 2-3 | 604 | 1108 | 18 | 21 | −3 | 22 | −4 |
| 2-4 | 481 | 941 | 14 | 17 | −3 | 19 | −5 |
| 2-5 | 515 | 996 | 16 | 18 | −2 | 20 | −4 |
| 2-101 | 416 | 834 | 25 | 15 | 10 | 17 | 8 |
| 2-102 | 431 | 858 | 28 | 15 | 13 | 17 | 11 |
| 2-103 | 200 | 480 | 17 | 7 | 10 | 10 | 7 |
| 2-104 | 481 | 941 | 20 | 17 | 3 | 19 | 1 |
| 2-105 | 630 | 1180 | 14 | 22 | −8 | 24 | −10 |

TABLE 9

| | Support Membrane | | | | | | | |
|---|---|---|---|---|---|---|---|---|
| | PTFE | | Basis | | Mean Flow | | | |
| Sample | Content | Thickness | Weight | Density | Pore Diameter | P3a | P3b | G3 |
| No. | [mass %] | [mm] | [mg/mm²] | [g/cm³] | [nm] | [kPa] | [kPa] | [s] |
| 2-1 | 100 | 0.021 | 0.0072 | 0.342 | 340 | 73 | 134 | 2 |
| 2-2 | 100 | 0.016 | 0.0055 | 0.342 | 340 | 73 | 134 | 2 |
| 2-3 | 100 | 0.023 | 0.0079 | 0.342 | 340 | 73 | 134 | 2 |
| 2-4 | 100 | 0.008 | 0.0027 | 0.342 | 340 | 73 | 134 | 2 |
| 2-5 | 100 | 0.016 | 0.0055 | 0.342 | 340 | 73 | 134 | 2 |
| 2-101 | 100 | 0.012 | 0.0041 | 0.342 | 340 | 73 | 134 | 2 |
| 2-102 | 100 | 0.011 | 0.0036 | 0.342 | 340 | 73 | 134 | 2 |
| 2-103 | 100 | 0.015 | 0.0051 | 0.342 | 340 | 73 | 134 | 2 |
| 2-104 | 100 | 0.020 | 0.0068 | 0.342 | 340 | 73 | 134 | 2 |
| 2-105 | 100 | 0.007 | 0.0024 | 0.342 | 340 | 73 | 134 | 2 |

TABLE 10

| | Stacked Body | | | |
|---|---|---|---|---|
| Sample | Thickness | Basis Weight | Density | Mean Flow Pore |
| No. | [mm] | [mg/mm²] | [g/cm³] | Diameter [nm] |
| 2-1 | 0.060 | 0.0203 | 0.338 | 26 |
| 2-2 | 0.056 | 0.0173 | 0.309 | 25 or less |
| 2-3 | 0.062 | 0.0172 | 0.277 | 26 |
| 2-4 | 0.018 | 0.0086 | 0.485 | 44 |
| 2-5 | 0.042 | 0.0114 | 0.271 | 35 |
| 2-101 | 0.032 | 0.0202 | 0.631 | 56 |
| 2-102 | 0.026 | 0.0175 | 0.673 | 58 |
| 2-103 | 0.037 | 0.0466 | 1.258 | 93 |
| 2-104 | 0.065 | 0.0350 | 0.538 | 34 |
| 2-105 | 0.020 | 0.0142 | 0.710 | 35 |

TABLE 11

| | Stacked Body | | | | | | |
|---|---|---|---|---|---|---|---|
| | | | | | G2 − | | G2 − |
| Sample | P2a | P2b | G2 | 0.040 × | (0.040 × | (0.025 × | [(0.025 × |
| No. | [kPa] | [kPa] | [s] | P2a | P2a) | P2b) − 6 | P2b) − 6] |
| 2-1 | 797 | 1465 | 29 | 32 | −3 | 31 | −2 |
| 2-2 | 742 | 1368 | 27 | 30 | −3 | 28 | −1 |
| 2-3 | 647 | 1234 | 24 | 26 | −2 | 25 | −1 |
| 2-4 | 512 | 1005 | 18 | 20 | −2 | 19 | −1 |
| 2-5 | 600 | 1125 | 20 | 24 | −4 | 22 | −2 |
| 2-101 | 425 | 852 | 31 | 17 | 14 | 15 | 16 |
| 2-102 | 466 | 905 | 34 | 19 | 15 | 17 | 17 |
| 2-103 | 270 | 598 | 30 | 11 | 19 | 9 | 21 |
| 2-104 | 508 | 984 | 25 | 20 | 5 | 19 | 6 |
| 2-105 | 664 | 1225 | 44 | 27 | 17 | 25 | 19 |

### <<Evaluation on Properties of Porous Membrane>>

For the porous membrane in the stacked body according to each sample, the content of polytetrafluoroethylene, thickness, basis weight, density, crystallite structure, mean flow pore diameter, average bubble point, and Gurley second were determined by the methods described in the first embodiment. The obtained results are shown in Tables 7 and 8.

### <<Evaluation on Properties of Support Membrane>>

For the support membrane in the stacked body according to each sample, the content of polytetrafluoroethylene, thickness, basis weight, density, mean flow pore diameter, average bubble point, and Gurley second were determined by the methods described in the third embodiment. The obtained results are shown in Table 9.

### <<Evaluation on Properties of Stacked Body>>

For the stacked body of each sample, the thickness, basis weight, density, mean flow pore diameter, average bubble point, and Gurley second were determined by the methods described in the “third embodiment”. The obtained results are shown in Tables 10 and 11. When the P2a and the P2b are relatively high, it means that the capturing performance for fine particles is relatively excellent. When the Gurley second is relatively low, it means that the permeation efficiency is relatively excellent.

### <Capturing Performance for Fine Particles and Permeation Efficiency>

Each of the stacked bodies according to samples 2-1 to 2-5 corresponds to an example of the present disclosure. On the other hand, each of the stacked bodies according to samples 2-101 to 2-105 corresponds to a comparative example. Each of the stacked bodies of samples 2-1 to 2-5, each of which satisfies the relation of the formula 1 or the formula 2 and the relation of the formula 3 or the formula 4, has much more excellent “capturing performance for fine particles” than that of each of the stacked bodies according to samples 2-101, 2-102, 2-103, and 2-104, each of which does not satisfy at least one of the relation of the formula 1 or the formula 2 and the relation of the formula 3 or the formula 4. Moreover, each of the stacked bodies according to samples 2-1 to 2-5, each of which satisfies the relation of the formula 1 or the formula 2 and the relation of the formula 3 or the formula 4, has much more excellent permeation efficiency than that of each of the stacked bodies according to samples 2-102 and 2-105, each of which does not satisfy at least one of the relation of the formula 1 or the formula 2 and the relation of the formula 3 or the formula 4. That is, each of the stacked bodies according to samples 2-1 to 2-6, each of which satisfies the relation of the formula 1 or the formula 2 and the relation of the formula 3 or the formula 4, can exhibit such a particularly excellent effect that the stacked body has both excellent “capturing performance for fine particles” and excellent permeation efficiency as compared with each of the stacked bodies according to samples 2-101 to 2-105, each of which does not satisfy at least one of the relation of the formula 1 or the formula 2 and the relation of the formula 3 or the formula 4.

In view of the above, it was found that each of the stacked bodies according to samples 2-1 to 2-5 exhibits such a particularly excellent effect that the stacked body can have both excellent “capturing performance for fine particles” and excellent permeation efficiency.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

1 porous membrane; 2 support membrane; 10 stacked body; 500 filter element; 520, 540 protective member; 590 liquid collection port; 550 core; 510 outer peripheral guard; 560a, 560b end plate; 600 gasket; 580 outlet; 570 porous membrane; 670 stacked body.

1. A porous membrane comprising polytetrafluoroethylene as a main component, wherein
the porous membrane has a Gurley second and an average bubble point,
the Gurley second and the average bubble point satisfy a relation of the following formula 1 or formula 2:
G1<0.035×P1a Formula 1
G1<0.020×P1b Formula 2
in each of the formula 1 and the formula 2, G1 represents the Gurley second of the porous membrane,
in the formula 1, P1a represents the average bubble point of the porous membrane,
the P1a is measured by a bubble point method using a first-a liquid,
a surface tension of the first-a liquid is 13 mN/m,
in the formula 2, P1b represents the average bubble point of the porous membrane,
the P1b is measured by a bubble point method using a first-b liquid, and
a surface tension of the first-b liquid is 21 mN/m.

2. The porous membrane according to claim 1, wherein
the P1a is 450 kPa or more, and
the P1b is 900 kPa or more.

3. The porous membrane according to claim 1, wherein
the porous membrane has a crystallite,
the crystallite has a length X along an MD direction of the porous membrane and a length Y along a TD direction of the porous membrane, and
a product XY of the length X and the length Y is less than 1200 nm².

4. A filter element comprising the porous membrane according to claim 1.

5. A stacked body comprising: one or a plurality of the porous membranes according to claim 1; and a support membrane located on one surface or each of both surfaces of at least one porous membrane of the porous membranes, wherein
the support membrane is porous,
the support membrane includes polytetrafluoroethylene as a main component,
the stacked body has a Gurley second and an average bubble point,
the Gurley second of the stacked body and the average bubble point of the stacked body satisfy a relation of the following formula 3 or formula 4:
G2<0.040×P2a Formula 3
G2<(0.025×P2b)−6 Formula 4
in each of the formula 3 and the formula 4, G2 represents the Gurley second of the stacked body,
in the formula 3, P2a represents the average bubble point of the stacked body,
the P2a is measured by a bubble point method using a second-a liquid,
a surface tension of the second-a liquid is 13 mN/m,
in the formula 4, P2b represents the average bubble point of the stacked body,
the P2b is measured by a bubble point method using a second-b liquid, and
a surface tension of the second-b liquid is 21 mN/m.

6. The stacked body according to claim 5, wherein
the P2a is 510 kPa or more, and
the P2b is 1000 kPa or more.

7. A filter element comprising the stacked body according to claim 5.
